(19) United States
(12) Patent Application Publication
(10) Pub. No.: US 2016/0167080 A1
(43) Pub. Date: Jun. 16, 2016

(54) COATING DEVICE

(71) Applicant: Industrial Technology Research Institute, Hsinchu (TW)

(72) Inventors: Chun-An Lu, New Taipei City (TW); Yuan-Ling Tsai, Changhua County (TW); Chiung-Hsiung Chen, Hsinchu County (TW); Jiun-Jang Yu, Hsinchu City (TW); Chin-Tien Yang, New Taipei City (TW)

(21) Appl. No.: 14/948,395

(22) Filed: Nov. 23, 2015

(30) Foreign Application Priority Data
Dec. 16, 2014 (TW) 103222263

(51) Int. Cl. B05C 9/02; B05C 5/00

(52) U.S. Cl. CPC B05C 9/02; B05C 5/001

(57) ABSTRACT

A coating device is provided, and includes a coater and an electrical field generator. The coater contains a slurry or ink and has an outlet. The slurry or ink is coated on a substrate through the outlet. The substrate is disposed adjacent to the outlet, and loads the slurry or ink from the outlet of the coater to form a wet film. The electrical field generator is disposed under the substrate and provides the electrical field, and thus the wet film stacks tightly on the substrate due to the attraction of the electrical field.

### CROSS-REFERENCE TO RELATED APPLICATION

This application claims the priority benefit of Taiwan application serial no. 103222263, filed on Dec. 16, 2014. The entirety of the above-mentioned patent application is hereby incorporated by reference herein and made a part of this specification.

### TECHNICAL FIELD

The technical field relates to a coating device.

### BACKGROUND

In recent years, smart handheld devices have become the main and the latest trend in consumer electronics. Except the features of the product, other factors, such as lightweight, thin, and size reduction are becoming the main considerations to attract the consumers to buy. Therefore, the miniaturized chip scale package (CSP) technology, like as 3DIC or functional modules, with thinner thickness and downsize is currently adopted to meet the requirements of the trend of the mobile electronic product appearance.

Traditional ceramic process is tape casting technology, and some applications are slot die coating technology and electrophoresis deposition. Generally, tape casting and slot die coating processes required for a thinner ceramic layer are the dispersion of ceramic powder slurry technology and the uniform mixing technology of slurry or ink compound. In order to decrease the thickness of the ceramic layer after coating, the finer and nano-scale powder is adopted, the mixture and the dispersion of the prepared slurry or ink affect the characteristics of the ceramic green tape or sheet. In other words, the powder must be appropriately dispersed in the slurry, so as to prevent ununiformity when coating due to slurry reunion or non-uniform, etc. However, when the powder is well dispersed in the slurry, the powder stacks loosely or untightly and the powder deposited is undensified, after coating, so as to have an adverse influence on the sintering process after coating and film characteristic. In other words, the characteristic of the well-dispersed slurry is not easy stacked for sedimentation, so that the density of the ceramic green tape or sheet and sintered density of the ceramic layer are not good.

On the other hand, electrophoresis deposition (EPD) process is a coating process different from tape casting or slot die coating. In EPD process, colloidal particles suspended in a liquid medium migrate under the influence of an electric field or electrophoresis and are deposited onto an electrode. Then all of the colloidal particles that can form stable suspensions and carry a charge can be used in EPD. EPD process is industrially used for applying coatings to metal fabricated products. It has been widely used to coat automobile bodies and parts, tractors and heavy equipment, electrical switch gear, appliances, metal furniture, beverage containers, fasteners, and many other industrial products. However, EPD process only has been used in coating material as a single layer and it is difficult to control the material. Furthermore, the cost of EPD process is high for industry.

### SUMMARY

One of exemplary embodiments comprises a coating device. The coating device includes a coater and an electrical field generator. The coater contains a slurry or ink and has an outlet. The slurry or ink is coated on a substrate through the outlet. The substrate is disposed adjacent to the outlet, and loads the slurry or ink from the outlet of the coater to form a wet film. The electrical field generator is disposed under the substrate and provides an electrical field, and thus the wet film stacks tightly on the substrate due to the attraction of the electrical field.

Several exemplary embodiments accompanied with FIGURES are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic view of a coating device according to an exemplary embodiment.

### DESCRIPTION OF THE EMBODIMENTS

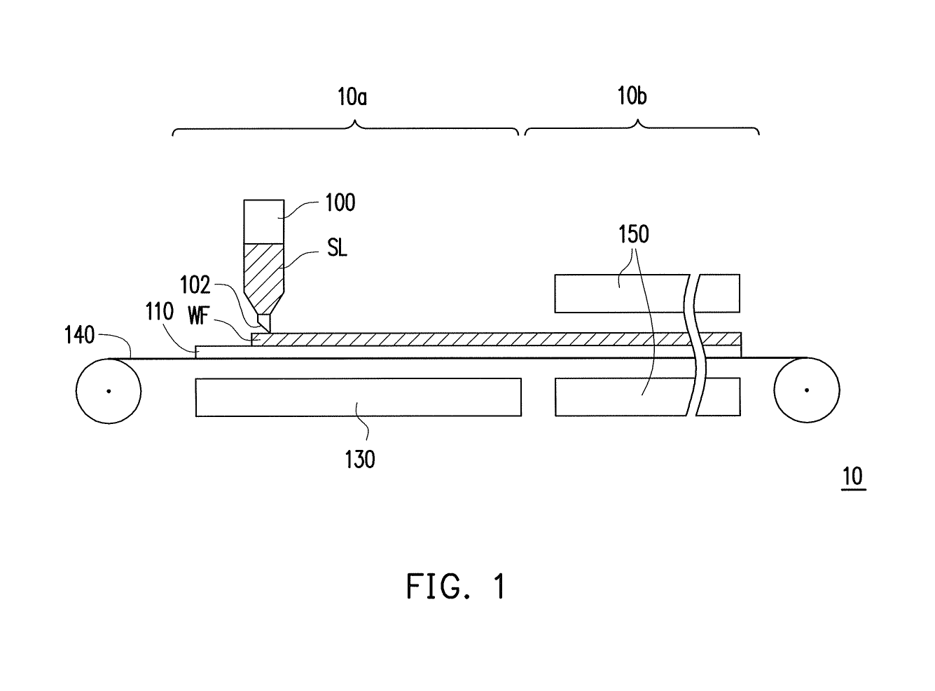

FIG. 1 is a schematic view of a coating device according to an exemplary embodiment. A coating device 10 includes a coater 100, a substrate 110, and an electrical field generator 130. In the present embodiment, the coating device 10, for example, further includes a conveying mechanism 140 and a heater 150. The coating device 10, for example, includes a coating zone 10a and a drying zone 10b. The coater 100 and the electrical field generator 130 are located at the coating zone 10a, the heater 150 is located at the drying zone 10b, and the substrate 110 and the conveying mechanism 140 are simultaneously located at the coating zone 10a and the drying zone 10b. The coater 100 contains slurry or ink SL and has an outlet 102. The slurry or ink SL is, for example, inorganic powder slurry or ink which includes inorganic powder, macromolecular material, and solvent after mixing. The particle diameter of the inorganic powder is in nanometer-scale or submicron-scale, for example, the particle diameter is smaller than 500 nm. The inorganic powder may include metal oxide, and in some embodiment, the metal oxide can be represented by AOₓ, A₂O₃, ABO₃ etc., wherein A and B are different metals, for example. The inorganic powder is, for example, ceramic powder. In the present embodiment, the inorganic powder is, for example, BaTiO₃. The macromolecular material includes polyvinyl butyral resin (PVB), Polyvintl Alcohol resin (PVA), Poly(methyl methacrylate) resin (PMMA), Carboxymethyl Cellulose (CMC), Ethyl Cellulose (EC) etc. The solvent can be a single solvent or can have many solvents mixed together with an appropriate ratio, and the solvent can include toluene, ethanol, water, butyl acetate, diethylene glycol monobutyl ether acetate, methanol, α-Terpineol, dibasic esters (DBE) etc.

The slurry or ink SL is coated on the substrate 110 through the outlet 102. The substrate 110 is disposed adjacent to the outlet 102, and loads the slurry or ink SL from the outlet 102 of the coater 100 to form a wet film WF. The substrate 110 is, for example, located on the conveying mechanism 140, and thus the substrate 110 and the wet film WF subsequently formed on the substrate 110 are moved by the conveying mechanism 140 from the coating zone 10a to the drying zone 10b. The material of the substrate 110 is stainless steel material or macromolecular material, such as polyethylene terephthalate (PET), polyethylene (PE), or polyimide (PI), etc.

In the present embodiment, the outlet 102 of the coater 100 includes a scraper, and the slurry or ink SL is coated uniformly on the substrate 110 by the scraper, so as to form the sheet-like wet film WF. In other embodiments, the outlet 102 of the coater 100 can also include a slot coating die or a screen printing mold. When the outlet 102 of the coater 100 include the slot coating die, the slurry or ink SL is pumped into the coater 100 by a quantitative pump so as to flow out from the outlet 102, which has narrow channels, in fluid state, and to flow to the substrate 110 which is located adjacent to the outlet 102 and moved at high-speed by the conveying mechanism 140, and then to form the sheet-like wet film WF by coating.

The electrical field generator 130 is disposed under the substrate 110 and provides the electrical field, and thus the wet film WF stacks tightly on the substrate 110 due to the attraction of the electrical field. In the present embodiment, the electrical field generator 130 is located at the coating zone 10a. The electrical field generator 130 includes an electrostatic attraction film which can be a polyimide film. The strength of the electrical field is, for example, from 0.1 kV to 10 kV. In the present embodiment, at a time when the substrate 110 is coated with the slurry or ink SL, the electrical field generator 130 generates an electrical field at the bottom of the substrate 110, so as to generate the electrostatic attraction force, and to achieve effects such as acceleration of sedimentation and tightly stacking of the slurry or ink SL. It should be noted that although the substrate 110 and the wet film WF are located at a local area as an example in FIG. 1, the substrate 110 is the continuous film located on the conveying mechanism 140 and the wet film WF is a continuous strip.

It is noted that in the embodiments, the slurry or ink SL is coated on the substrate 110, and then the particles in the slurry or ink SL coated on the substrate 10 is deposited quickly and densely on the substrate 10 due to an attraction of the electrical field generated by the electrical field generator 130.

In the present embodiment, the conveying mechanism 140 is, for example, is a roller device. In the present embodiment, the heater 150 is, for example, arranged downstream the electrical field generator 130 along a conveying direction of the substrate 110, so as to dry the wet film WF. The coating zone 10a and the drying zone 10b are, for example, not overlapped with each other, and thus the heater 150 and the electrical field generator 130 are configured to be not overlapped with each other. In other words, the substrate 110 and the wet film WF on the substrate 110 enter the drying zone 10b after, for example, departing from the coating zone 10a. The heater 150 is, for example, located at two opposite sides of the coating zone 10a, so that two surfaces of the wet film WF are uniformly heated and dried by the heater 150 when passing through the heater 150. Furthermore, in one embodiment, the heater 150 can be located at one side of the coating zone 10a, or the heater 150 can be other heating device such as a contact type heating band. The heater 150 provides, for example, the heating temperature from 60° C. to 70° C., so as to dry the coated wet film WF. The density of the wet film WF is improved by the electrical field generator 130. For example, a thickness of the wet film WF may be smaller than 1 μm after drying. In the present embodiment, the wet film WF after drying is, for example, wound around a roller at the rear end of the conveying mechanism 140, in other words, the coating device 10 is used in a roll to roll process which can coat continuously. Certainly, in other embodiments, the coating device can also be accompanied with a coating method and can have other devices different from roller.

In the present embodiment, the electrical field polarity generated by the electrical field generator 130, which is configured under the substrate 110, is adjusted according to the electric charge of the slurry or ink SL. For example, if the slurry or ink SL is negative charged and the surface of the electrical field generator 130 is positive charged, the slurry or ink SL can deposit rapidly and tightly on the substrate 110 because of the electrostatic attraction effect between the slurry or ink SL and the electrical field generator 130. As a result, except that the time of the total process is greatly shortened, the wet film WF formed on the substrate 110 has a smaller thickness and a greater density, so as to decrease the manufacturing cost and to increase the film quality of the wet film WF. Furthermore, in the subsequent high temperature sintering process, a ceramic body having higher sintered density can be obtained.

Next, experimental example and comparative example are provided to describe the characteristic of the ceramic body produced by adopting the coating device of an exemplary embodiment.

### Experimental Example

Firstly, the BaTiO₃ powder having 200 nm particle diameter (purchased from Sakai Chemical Industry Co., Japan), PVB macromolecular material, and a solvent of toluene and alcohol (weight ratio is 7:3) were mixed uniformly to form the ceramic slurry, and then the ceramic slurry was filled in the coater. Subsequently, the ceramic slurry was coated on the PET substrate by a scraper, and simultaneously the electrical field generator under the PET substrate provided a 1000V electrical field, so as to generate electrostatic attraction between the wet film coated on the substrate and the electrical field generator. After that, the wet film was dried by the heater for 30 minutes at 600° C., so as to form the ceramic body. Afterwards, the ceramic body was sintered for 8 hours at 1050° C. After sintering, the bulk density of the ceramic body was calculated by using Archimedes' principle, and a bulk density of the ceramic body was obtained as 5.81 g/cm³.

### Comparative Example

Firstly, the BaTiO₃ powder having 200 nm particle diameter (purchased from Sakai Chemical Industry Co., Japan), PVB macromolecular material, and a solvent of toluene and alcohol (weight ratio is 7:3) were mixed uniformly in the coater, so as to form the ceramic slurry. Subsequently, the ceramic slurry was coated on the PET substrate by a scraper. After that, the wet film was dried by the heater for 30 minutes at 600° C., so as to form the ceramic body. Afterwards, the ceramic body was sintered for 8 hours at 1050° C. After sintering, the bulk density of the ceramic body was calculated by using Archimedes' principle, and a bulk density of the ceramic body was obtained as 5.65 g/cm³.

According to above-mentioned experimental example and comparative example, the electrical field generator is provided under the substrate, so as to generate the electrostatic attraction between the wet film coated on the substrate and the electrical field, and then to increase the density of the ceramic body after sintering. Consequently, the attraction force between the wet film coated on the substrate and the electrical field is beneficial to stack the slurry or ink tightly, so as to increase the density of the wet film, and to generate the ceramic body having a higher density.

In summary, the electrical field generator is provided under the substrate which is coated with the slurry or ink, so that the slurry or ink is deposited on the substrate due to the electrostatic attraction by the electrical field, and accordingly the ceramic powder deposits rapidly and tightly on the substrate. As a result, the time of the total process is greatly shortened, and the wet film formed on the substrate has a smaller thickness and a greater powder packing density, so as to decrease the manufacturing cost of the wet film and to obtain the ceramic body or layer having higher sintered density in the subsequent high temperature sintering process.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A coating device, comprising:
a coater, containing a slurry or ink and having an outlet, wherein the slurry or ink is coated on a substrate through the outlet, the substrate is disposed adjacent to the outlet and loads the slurry or ink from the outlet of the coater to form a wet film; and
an electrical field generator, disposed under the substrate and providing an electrical field, wherein the wet film stacks tightly on the substrate due to an attraction of the electrical field.

2. The coating device as recited in claim 1, wherein the electrical field generator comprises an electrostatic attraction film.

3. The coating device as recited in claim 1, wherein a strength of the electrical field is from 0.1 kV to 10 kV.

4. The coating device as recited in claim 1, wherein the outlet of the coater comprises a scraper, a slot coating die or a screen printing mold.

5. The coating device as recited in claim 1, further comprising a conveying mechanism, wherein the substrate is located on the conveying mechanism.

6. The coating device as recited in claim 1, further comprising a heater, wherein the heater is arranged downstream the electrical field generator along a conveying direction of the substrate, so as to dry the wet film.
